(19) United States
(12) Patent Application Publication
(10) Pub. No.: US 2011/0049966 A1
(43) Pub. Date: Mar. 3, 2011

(54) WHEEL HUB

(75) Inventors: Robert Sartin, Somerset (GB); Michael Mullett, Somerset (GB)

(73) Assignee: TALON ENGINEERING LIMITED, Yeovil (GB)

(21) Appl. No.: 12/857,121

(22) Filed: Aug. 16, 2010

(30) Foreign Application Priority Data
Aug. 26, 2009 (GB) GB0914879.2

(51) Int. Cl. B60B 27/00; B21D 53/26

(52) U.S. Cl. 301/110.5

(57) ABSTRACT

A wheel hub includes a hub center and an end part. The hub center has, towards a first end thereof, a first attachment formation that includes a bearing face. The end part has an attachment formation which is configured to receive the first attachment formation of the hub center. The attachment formation includes a bearing face which is complementary to the bearing face of the hub center such that when the first attachment formation of the hub center is received in the attachment formation of the end part, the bearing face of the hub center bears against the bearing face of the end part.

### TECHNICAL FIELD

The present disclosure relates to a wheel hub and to a method of manufacturing a wheel hub.

### BACKGROUND

Spoked wheels for vehicles such as trail motorcycles typically have a central hub and a rim for carrying a tire, with supporting spokes extending from the hub to the rim. Typically the hub is made from a lightweight material such as aluminium, and is machined from a billet of aluminium to form a unitary hub. This manufacturing method is very wasteful, as due to the shape of the hub a large amount of aluminium must be removed and disposed of as waste material.

Efforts have been made to overcome this problem. In one method, a wheel hub is manufactured in three parts: a hub center and two hub end parts having carriers for brake discs and drive chain sprockets respectively. The hub center is formed with a radially-extending terminal flange at each end, and the end parts are attached to the hub center by means of bolts, rivets or other fixing means which pass through apertures in the respective flanges and end parts to secure the respective end parts to the flanges. A disadvantage of this manufacturing method is that torque from a drive chain of the vehicle to which the wheel is attached is transferred through the bolts to drive the wheel. The bolts (or other fixing means) must therefore be extremely strong, which can lead to excessive weight. Any compromise on the weight of the bolts results in reduced reliability, as one or all of the bolts may shear due to the forces applied in use of the hub.

An alternative approach is to use a carbon fiber hub center with end parts attached to each end by means of an adhesive. This approach overcomes the problem of excessive weight, but requires the use of expensive carbon fiber. Moreover, the process of securing the end parts to the hub center using adhesive is extremely labor intensive and time consuming, requiring many hours of curing and baking in an oven before the wheel hub is complete.

### SUMMARY

According to a first aspect there is provided a wheel hub comprising a hub center and an end part, the hub center having towards a first end thereof a first attachment formation comprising a bearing face, and the end part having an attachment formation which is configured to receive the first attachment formation of the hub center and which comprises a bearing face which is complementary to the bearing face of the hub center such that when the first attachment formation of the hub center is received in the attachment formation of the end part the bearing face of the hub center bears against the bearing face of the end part.

The wheel hub may offer reduced manufacturing costs over prior art systems, as it is not of a unitary construction thereby reducing the amount of material wasted in comparison to prior art methods. The mutual engagement of the bearing faces of the hub center and the complementary bearing faces of the end part assists in providing a close interference fit between the hub center and the end part whilst also providing for efficient transfer of torque from the hub center to the end part and thence to the wheel rim.

The hub center further may further comprise, towards a second end thereof, a second attachment formation comprising a bearing face, the second attachment formation being configured to be received in the attachment formation of the end part.

One or both of the first and second attachment formations of the hub center may comprise a peripheral flange which extends radially outwardly of the hub center, and the attachment formation of the end part may comprise a receiving formation for receiving the peripheral flange of the first or second attachment formation of the hub center.

The peripheral flange may comprise a plurality of bearing faces.

The peripheral flange and the receiving formation may be in the form of a nonagon.

One or both of the first and second attachment formations of the hub center may further comprise a generally cylindrical section which extends coaxially with the hub center, and the attachment formation of the end part may further comprise a bore for receiving the generally cylindrical section of the attachment formation of the hub center.

The generally cylindrical section may terminate in a generally open-ended tapering portion which defines an outer end of the hub center.

The bore and the receiving formation of the attachment formation of the end part may be concentric.

The end part may comprise a shoulder formed at an interface of the bore and the receiving formation of the attachment formation of the end part.

The second attachment formation may be angularly offset with respect to the first attachment formation.

According to a second aspect there is provided a hub center for a wheel hub according to the first aspect.

According to a third aspect there is provided an end part for a wheel hub according to the first aspect.

According to a fourth aspect there is provided a method of manufacturing a wheel hub according to the first aspect, the method comprising the steps of producing a hub center having towards a first end thereof a first attachment formation comprising a plurality of bearing faces, producing an end part having an attachment formation comprising a plurality of bearing faces, the attachment formation of the end part being configured to receive the attachment formation of the hub center, and attaching the hub center to the end part such that the bearing faces of the hub center bear against the bearing faces of the end part.

The attachment formation of the end part may comprise a through bore and a receiving formation which is concentric with the through bore, and the method may comprise forming the through bore and the receiving section simultaneously.

The method may further comprise the step of inserting into a central bore of the hub center a bearing assembly.

### BRIEF DESCRIPTION OF THE DRAWINGS

Embodiments of the wheel hub and method of manufacturing will now be described, strictly by way of example only, with reference to the accompanying drawings, of which:

FIG. 1 is an exploded cross-sectional view showing elements of a wheel hub according to an embodiment;

FIG. 2 is a view from one end of a hub center; and

FIG. 3 is a schematic representation of part of a hub end part.

### DESCRIPTION OF THE EMBODIMENTS

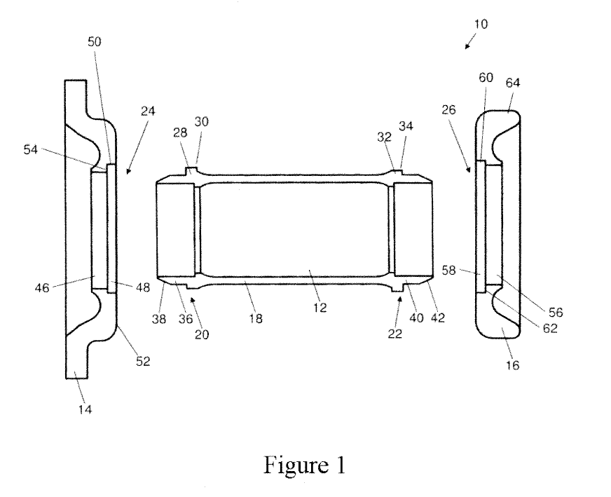

Referring first to the exploded cross-sectional view of FIG. 1, a wheel hub according to an embodiment is shown generally at 10, and comprises a hub center 12 and first and second hub end parts 14, 16. In this example the wheel hub 10 is for a spoked front wheel of a motorcycle, but it will be appreciated that the principles of the disclosed wheel hub and method of manufacturing are also applicable to other wheels. The hub center 12 comprises a hollow, generally cylindrical tube 18 defining a central bore in which a bearing assembly can be received such that the hub 10 can be rotatably mounted on an axle or the like. Towards each end of the hub center 12 there are provided first and second attachment formations 20, 22, each of which is configured to engage with a complementary attachment formation 24, 26 of the respective hub end part 14, 16.

The first attachment formation 20 has a peripheral flange 28 which extends radially outwardly of the cylindrical tube 20 of the hub center 12. The peripheral flange 28 is provided with a plurality of outwardly-facing engagement faces 30 which are configured to engage with complementary engagement faces of the attachment formation 24 of the first hub end part 14, as is described in more detail below.

Similarly, the second attachment formation 22 has a peripheral flange 32 which extends radially outwardly of the cylindrical tube 20 of the hub center 12. The peripheral flange 32 is provided with a plurality of outwardly-facing engagement faces 34 which are configured to engage with complementary engagement faces of the attachment formation 26 of the second hub end part 16, as is described in more detail below.

The first attachment formation 20 includes a hollow cylindrical section 36 which extends coaxially with the cylindrical tube 20 of the hub center. The hollow cylindrical section 36 terminates in a generally open-ended frusto-conical tapering portion 38 which defines an open, generally circular, first outer end of the hub center 12. Thus, the first attachment formation 20 of the hub center 12 has three sections of decreasing diameter: the peripheral flange 28, which has the greatest diameter; the cylindrical section 36, which has a smaller diameter than the peripheral flange 28; and the open outer end of the tapering portion 38, which has a smaller diameter than the cylindrical section 36.

The second attachment formation 22 has a similar configuration to the first attachment formation 20, including a hollow cylindrical section 40 which extends coaxially with the cylindrical tube 20 of the hub center. The hollow cylindrical section 40 terminates in a generally open-ended frusto-conical tapering portion 42 which defines an open, generally circular, second outer end of the hub center 12. Thus, the second attachment formation 22 of the hub center 12 also has three sections of decreasing diameter: the peripheral flange 32, which has the greatest diameter; the cylindrical section 40, which has a smaller diameter than the peripheral flange 32; and the open outer end of the tapering portion 42, which has a smaller diameter than the cylindrical section 40.

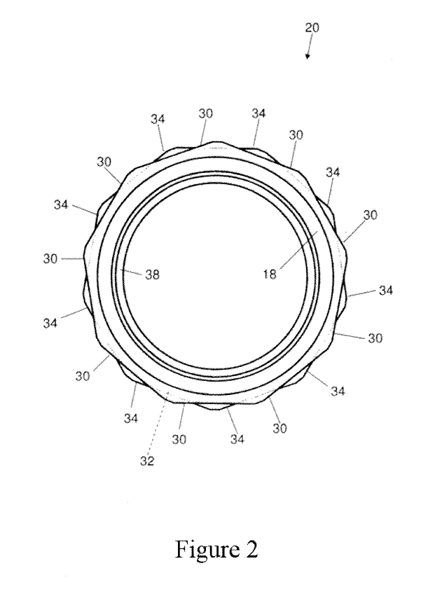

The first attachment formation 20 of the hub center 12 will now be described in more detail by reference to FIG. 2, which is a view from one end of the hub center 12.

As will be seen from FIG. 2, the peripheral flange 28 is in the form of a nonagon, and thus there are nine generally flat engagement faces 30. In the example the hub 10 is intended for use in a wheel having thirty-six spokes (i.e. eighteen spokes on each of the first and second end parts 14, 16), so a nonagon-shaped peripheral flange 28 is particularly appropriate as it provides for an even distribution of spokes (two per engagement face 30) around the diameter of the hub 10. It will be appreciated however that the peripheral flange 28 can take any shape, provided that it has at least one generally flat engagement face 30 which can engage with a corresponding engagement face of a hub end part 14, 16.

The second engagement formation 22 has a similar configuration of a nonagonal peripheral flange 32 having nine generally flat engagement faces 34, although again the peripheral flange 32 can take any shape, provided that it has at least one generally flat engagement face 34 can engage with a corresponding engagement face of a hub end part 14, 16. It will be apparent from FIG. 2 that the peripheral flange 32 of the second attachment formation 22 is angularly offset with respect to the peripheral flange 28 of the first attachment formation 20 to permit correct timing of spokes attached to the hub 10.

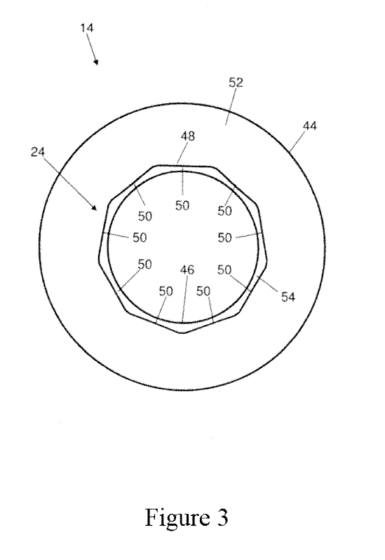

The engagement formation 24 of the first hub end part 14 will now be described with reference to FIG. 3, which is a schematic representation of a hub end part. The hub end part 14 has a main body 44 with a plurality of equispaced holes or bores for accommodating spokes disposed towards its outer edge. As these are not relevant, they are not shown in FIG. 3 for reasons of clarity, but the position, size and orientation of these holes or bores will be readily apparent to those skilled in the art of wheel hub manufacture. The hub end part 14 also includes attachment formations such as threaded bores for the attachment of a brake disc or the like, although again these are not shown in FIG. 3 since they do not form part of the disclosed wheel hub and method of manufacturing.

The attachment formation 24 of the first hub end part 14 is positioned in the center of the main body 44 and has a generally cylindrical through bore 46 whose diameter is equal to or very slightly larger than the diameter of the cylindrical portion 36 of the first attachment formation 20 of the hub center. The bore 46 opens out into a receiving formation 48, which is concentric with the through bore, and is in the shape of a nonagon having nine internal, inwardly-facing engagement faces 50. The diameter of the receiving formation 48 is equal to or very slightly greater than that of the peripheral flange 28 of the first attachment formation 20 of the hub center 12. Thus, an inner face 52 of the first hub end part 14 presents a nonagonal receiving formation 48 which is complementary to the shape of the peripheral flange 28 of the first attachment formation 20 of the hub center 12 in which the peripheral flange 28 can be received, such that the engagement faces 30 of the peripheral flange 28 bear against the engagement faces 50 of the attachment formation 24 of the first hub end part 14. A shoulder 54 is formed at the interface of the through bore 46 and the receiving formation 48, which shoulder 54 acts as a stop for the peripheral flange 28 of the first attachment formation 20 of the hub center 12 when it is received in the attachment formation 24 of the first end part 14.

The attachment formation 26 of the second hub end part 16 has the same structure as the attachment formation 24 of the first hub end part 14, having a central cylindrical through bore 58 opening out into a concentric nonagonal receiving formation 58 of a diameter equal to or slightly greater than that of the peripheral flange 32 of the second attachment formation 2 of the hub center 12. The receiving formation 58 has nine inwardly facing engagement faces 60 which bear against the engagement faces 34 of the peripheral flange 32 of the second attachment formation 22 when the peripheral flange 32 is received in the receiving formation 58. A shoulder 62 is formed at the interface of the through bore 56 and the receiving formation 58, which acts as a stop for the peripheral flange 32 of the second attachment formation 22 when the peripheral flange 32 is received in the receiving formation 58. In this example the diameter of a body 64 of the second hub end part 16 is smaller than that of the first end part 14, as the second end part does not have to carry a brake disc or other components. It will be appreciated however that the diameter of the second end part 16 could be equal to or greater than that of the first end part 14, depending upon the construction of the wheel in which the hub 10 is incorporated.

To manufacture the hub 10 described above, the hub center 12 and the first and second end parts 14, 16 are formed separately, for example by milling from billets of aluminium. Forming the hub center 12 and the first and second end parts 14, 16 separately in this way reduces the amount of waste material, since it not necessary to use a single large billet of aluminium to form the whole hub 10, but rather smaller billets can be used to form the individual parts 12, 14, 16. In forming the first end part 14 it is advantageous to mill the nonagonal receiving formation 48 and the through bore 46 simultaneously to ensure that they are concentric. Similarly, it is advantageous to mill the nonagonal receiving formation 58 and the through bore 56 of the second end part 16 simultaneously.

Once the hub center 12 and the first and second end parts 14, 16 have been formed the hub 10 can be assembled. The first attachment formation 20 of the hub center 12 is inserted into the attachment formation 24 of the first end part 14. The peripheral flange 28 of the first attachment formation 20 is aligned with the complementary receiving formation 48 of the first end part 14 and the hub center 12 and the first end part 14 are urged together. The inwardly tapering portion 38 of the first attachment formation 20 of the hub center 12 reduces the risk of misalignment of the first attachment formation 20 of the hub center 12 and the attachment formation 24 of the first end part 14.

As the hub center 12 and the first end part are urged together the engagement faces 30 of the peripheral flange engage with the complementary engagement faces 50 of the first end part 14, whilst the outer surface of the cylindrical portion 36 of the first engagement formation of the hub center 12 engages with the outer surface of the through bore 46 of the first end part 14. When the first attachment formation 20 of the hub center 12 is fully engaged with the attachment formation 24 of the first end part 14 the peripheral flange 28 bears against the shoulder 54 of the first end part 12, whilst the engagement faces 30 of the peripheral flange 28 bear against the complementary engagement faces 50 of the first end part 14. In attaching the first end part 14 to the hub center 12 the cylindrical portion 36 and the peripheral flange 28 may undergo some minor deformation due to the very similar (or identical) diameters of the cylindrical portion 36 and the through bore 46 and of the peripheral flange 28 and the receiving formation 48. These diameters ensure a very close interference fit between the cylindrical portion 36 and the through bore 46 and between the peripheral flange 28 and the receiving formation 48.

Once the first end part 14 has been attached to the first attachment formation 20 of the hub center 12 the second end part 16 is attached to the second attachment formation 22 of the hub center in a similar manner.

A bearing assembly is then inserted into the central bore defined by the cylindrical tube 18 of the hub center. Insertion of the bearing unit may cause the inwardly tapering portions 38, 42 of the first and second attachment formations 20, 22 of the hub center 12 to deform by flaring outwardly, thereby enhancing the interference fit engagement of the first and second attachment formations 20, 22 of the hub center with the attachment formations 24, 26 of the first and second end parts 14, 16.

This method of construction offers a number of advantages over prior art methods. A major advantage is the reduce waste of material in comparison to prior art methods. This method is quicker and more straightforward than the prior art method involving carbon fiber hub centers, whilst producing hubs with improved performance than the prior art method which uses a flanged hub to which hub end parts are bolted. The mutual engagement of the bearing faces 30, 34 of the first and second end parts 14, 16 and the complementary bearing faces 50, 60 of the receiving formations 24, 26 of the first and second end parts 14, 16 assists in providing a close interference fit between the respective attachment formations 20, 24 and 22, 26 whilst also providing for efficient transfer of torque from the hub center 12 to the end parts 14, 16 and thence to the wheel rim.

In the exemplary embodiment described above the wheel hub 10 is formed from three separate parts, the hub center 12 and the two hub end parts 14, 16. It will be appreciated, however, that the disclosed principles are equally applicable to other constructions, For example, the hub center 12 could be formed with an integral end part, with the other end part being attachable using attachment formations as described above. Alternatively, one end part 14, 16 could be attached to the hub center 12 using bolts or adhesive, as is known from the prior art, with the other end part 16, 14 being attachable using attachment formations as described above.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A wheel hub comprising:
a hub center; and
an end part,
the hub center having towards a first end thereof a first attachment formation comprising a bearing face, and the end part having an attachment formation which is configured to receive the first attachment formation of the hub center and which comprises a bearing face which is complementary to the bearing face of the hub center such that when the first attachment formation of the hub center is received in the attachment formation of the end part the bearing face of the hub center bears against the bearing face of the end part.

2. A wheel hub according to claim I wherein the hub center further comprises, towards a second end thereof, a second attachment formation comprising a bearing face, the second attachment formation being configured to be received in the attachment formation of the end part.

3. A wheel hub according to claim 2 wherein one or both of the first and second attachment formations of the hub center comprises a peripheral flange which extends radially outwardly of the hub center, and the attachment formation of the end part comprises a receiving formation for receiving the peripheral flange of the first or second attachment formation of the hub center.

4. A wheel hub according to claim 3 wherein the peripheral flange comprises a plurality of bearing faces.

5. A wheel hub according to claim 4 wherein the peripheral flange and the receiving formation are in the form of a nonagon.

6. A wheel hub according to claim 1 wherein one or both of the first and second attachment formations of the hub center further comprises a generally cylindrical section which extends coaxially with the hub center and the attachment formation of the end part further comprises a bore for receiving the generally cylindrical section of the attachment formation of the hub center.

7. A wheel hub according to claim 6 wherein the generally cylindrical section terminates in a generally open-ended tapering portion which defines an outer end of the hub center.

8. A wheel hub according to claim 6 wherein the bore and the receiving formation of the attachment formation of the end part are concentric.

9. A wheel hub according to claim 8 wherein the end part comprises a shoulder formed at an interface of the bore and the receiving formation of the attachment formation of the end part.

10. A wheel hub according to claim 3 wherein the second attachment formation is angularly offset with respect to the first attachment formation.

11. A hub center for a wheel hub according to claim 1.

12. An end part for a wheel hub according to claim 1.

13. A method of manufacturing a wheel hub according to claim 1, the method comprising:
producing a hub center having towards a first end thereof a first attachment formation comprising a plurality of bearing faces;
producing an end part having an attachment formation comprising a plurality of bearing faces, the attachment formation of the end part being configured to receive the attachment formation of the hub center; and
attaching the hub center to the end part such that the bearing faces of the hub center bear against the bearing faces of the end part.

14. A method according to claim 13 wherein the attachment formation of the end part comprises a through bore and a receiving formation which is concentric with the through bore, the method further comprising forming the through bore and the receiving section simultaneously.

15. A method according to claim 13 further comprising inserting into a central bore of the hub center a bearing assembly.
